(19) United States
(12) Patent Application Publication
(10) Pub. No.: US 2014/0175084 A1
(43) Pub. Date: Jun. 26, 2014

(54) REMOTELY CONTROLLED HEAT TREATMENT SYSTEM, REMOTE CONTROL SYSTEM FOR HEAT TREATING, AND METHOD FOR REMOTELY CONTROLLING A HEAT TREATMENT SYSTEM

(71) Applicants: Yoo-Chol Ji, Seoul (KR); Young-Jun Kim, Ansan-si (KR)

(72) Inventors: Yoo-Chol Ji, Seoul (KR); Young-Jun Kim, Ansan-si (KR)

(21) Appl. No.: 14/079,645

(22) Filed: Nov. 14, 2013

(30) Foreign Application Priority Data
Nov. 15, 2012 (KR) 10-2012-0129793

(51) Int. Cl. H05B 3/62

(52) U.S. Cl. CPC H05B 3/62
USPC 219/393

(57) ABSTRACT

A heat treatment system includes a heat treatment apparatus as a component. An example of the heat treatment apparatus may be a metal heat treatment apparatus which thermally treats metal material in a chamber. In managing the temperature of a particular space for a long time, a remote control method is provided. The remote monitoring and managing of the temperature of the particular space with high reliability is provided.

### BACKGROUND

This invention relates to a heat treatment system.

A metal heat treatment apparatus in the technical field relevant to this invention performs heat treatment process for a target material, such as a metal material, inside a chamber by controlling a heating device and a cooling device.

For a general metal heat treatment, when the temperature of a chamber is increased, the metal material inside the chamber is vulnerable to oxidation as the surface of the metal is exposed to oxygen. Therefore, in the heat treatment of highly expensive material, or high quality material, a vacuum heat treatment at lower pressure is used.

As shown in FIG. 1, a general vacuum heat treatment apparatus (1) comprises a vessel (100) and a chamber (111) disposed in the vessel and having a space heated by a heating device. The apparatus is connected with an air discharging line to create the vacuum chamber. A cooling device (115) cools the heated material. This vacuum heat treatment apparatus requires the air to be fully discharged in the chamber before starting heat treatment process with target material put inside the chamber. After performing heating under the state of full discharge, the chamber is cooled down to a target temperature by supplying inert gas, such as Argon gas or Nitrogen gas, into the chamber.

For measuring the temperature in the chamber, a general vacuum heat treatment uses at least a thermocouple sensor positioned at a thermocouple holder (116), of which location is appropriately adjustable depending on the location of the target material.

A general metal heat treatment apparatus has a disadvantage of time-wasting to an operator because operator has to attend whole heat treatment process for a long period of time near the heat treatment apparatus. For example, for an electric metal heat treatment apparatus, if the power is suddenly shut down and operator does not take action quickly to provide supplemental power, the heat treatment process is affected such that the target material may be damaged or unusable.

### SUMMARY

In managing the temperature of a particular space, a heat treatment system which can remotely control the temperature may be preferred. Further, it is more needed for a heat treatment system to be remotely controlled while being monitored. This invention is for providing a heat treatment system to meet such commercial needs.

One embodiment of this invention comprises a chamber separate from the outside space and of which temperature is controlled by a preset operation pattern; a heating device to heat the chamber; a cooling device to cool the chamber; a gas supply device to supply outer gas into the chamber; a sensor to detect a status of the chamber; a power supply device to supply power to the heating device, the cooling device, and an gas supply unit; a battery connected to the power supply device; a first memory where a plurality of operation pattern is stored; a second memory where status information measured from the senor is stored; a wireless communication module to receive a operation pattern selection command and a operation factor related to the operation pattern; and a controller which retrieve a operation pattern from the first memory according to the operation pattern selection command received, and control at least two out of the heating device, the cooling device, and the gas supply device, based on the operation pattern retrieved and the operation factor.

The cooling device can be located outside of the chamber. And, the battery is configured to supply power to at least one of the heating device, the cooling device and the gas supply unit. The battery, further while there is no power supply from the outside, can be set in order to supply power to at least one of the heating device, the cooling device, and the gas supply device.

The first memory and the second memory can be located in separate memory chips, or in a single memory chip.

And, each of a plurality of operation patterns stored in the first memory can has ID to identify itself.

And, the data received via wireless communication can include at least one of apparatus ID, operation pattern ID, operation factor, and information for determining whether information of operation status is requested or operation command is received. If the data received includes operation command, it can be set that some of the data not relevant to operation command should be disregarded.

And, the wireless communication module can be set to send status information when the chamber reaches to a particular operation factor. Further, in case that power is supplied from the battery, not outer power supply, the wireless communication module can be set to send alarm, or to send status information of the chamber and further residual time until reaching to an operation factor.

Meanwhile, this invention is not limited to treating metal material, and can be enlarged for treating non-metal material. Heat treating of material in a chamber is one of examples utilizing a heat treatment system of this invention. A heat treatment system in this invention can be regarded a system to treat heat for a particular space. Further, a part or the whole of a heat treatment system in this invention is utilized for remotely controlling temperature of a particular space.

As a embodiment of this invention, a heat treatment apparatus can be remotely controlled.

Further, by adding monitoring function, reliability of heat treatment via remote controlling can be guaranteed.

### BRIEF DESCRIPTION OF THE DRAWINGS

FIG. 1 shows a general metal heat treatment apparatus.

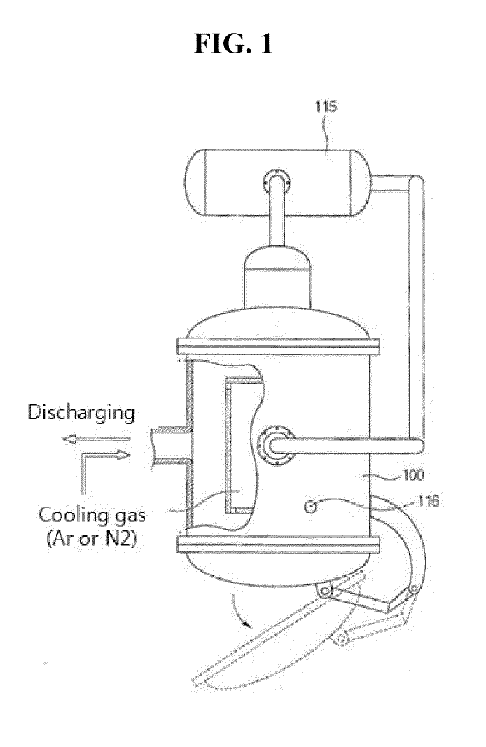

FIG. 2 shows an embodiment of heat treatment apparatus which constitute a part of this invented heat treatment system.

FIG. 3 shows a block diagram of a controller.

FIG. 4 shows a wireless communication module.

FIG. 5 shows a network system for remote control in this invention.

FIG. 6 shows operation patterns.

FIGS. 7 and 8 shows a remote control flow.

FIG. 9 shows a data format transferred for command.

FIG. 10 shows selection options for operation monitoring mode.

### DETAILED DESCRIPTION

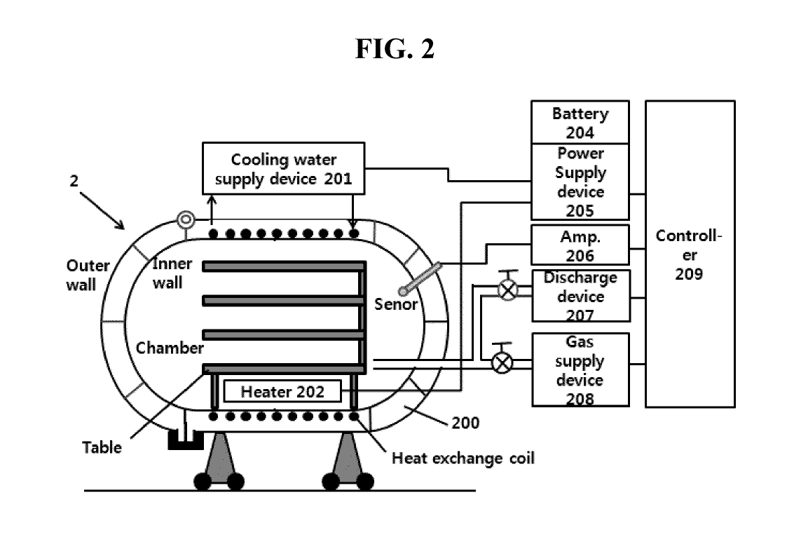

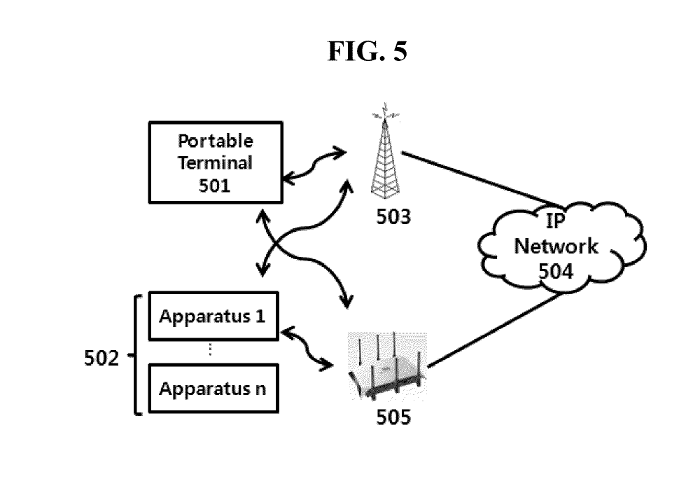

An embodiment of heat treatment system is explained with reference to FIG. 2 to FIG. 10. This embodiment comprises a metal heat treatment apparatus (2) (hereinafter “a heat treatment apparatus”). A heat treatment apparatus (2) includes a shell (20) having an outer wall and an inner wall forming a chamber inside. The shell (200) is positioned horizontally to allow easy placement and retrieval of the target material. The heat treatment apparatus is connected with a discharge device (207) to discharge air in the chamber to create the chamber vacuum. The discharge device (207) allows the chamber to be operated at lower pressure than a preset pressure before a heater (202) is turned on, or to discharge heated gas in the chamber after heat treatment process is finished. The heat treatment apparatus is connected with a gas supply device (208) capable of supplying outer gas inside the shell. The gas supply device allows rapid cooling of the chamber after a heating process is done by supplying Argon or Nitrogen gas inside the shell while gas in the chamber is discharged by the discharge device simultaneously. In case of a special metal, such as Inconnel, which is resistant to oxidization, outer gas can be supplied into the chamber instead of expensive inert cooling gas. Further, to increase the cooling speed, after supplying outer air or inert gas into the shell, a cooling water supply device may supply a cooling water to a cooling coil which surrounds the inner wall.

A heater (202), a cooling water supply device (201), a discharge device (207) and a gas supply device (208) are supplied with external power through a power supply device (205). Depending on the system, a plurality of power supply device can be installed to independently supply power to a heater which requires much power from other devices. Other various combinations of power supply configuration can be made for maximizing power operation efficiency. The power supply device may be also connected to a battery (204). The battery (204) can supply power to the devices when the external power is cut off. Due to the limited power capacity of battery, the heat treatment process cannot be completed if the external power is cut off during an initial stage of heat treatment process. However, as long as the external power is not supplied during a final stage, the heat treatment process can be completed with help of a battery. In case of highly expensive metals, such as Inconnel, unexpected stoppage of the heat treatment process due to a failure of power supply causes much loss. Therefore, a battery as a supplemental power source in the heat treatment system can prevent material loss in case of failure in the external power supply.

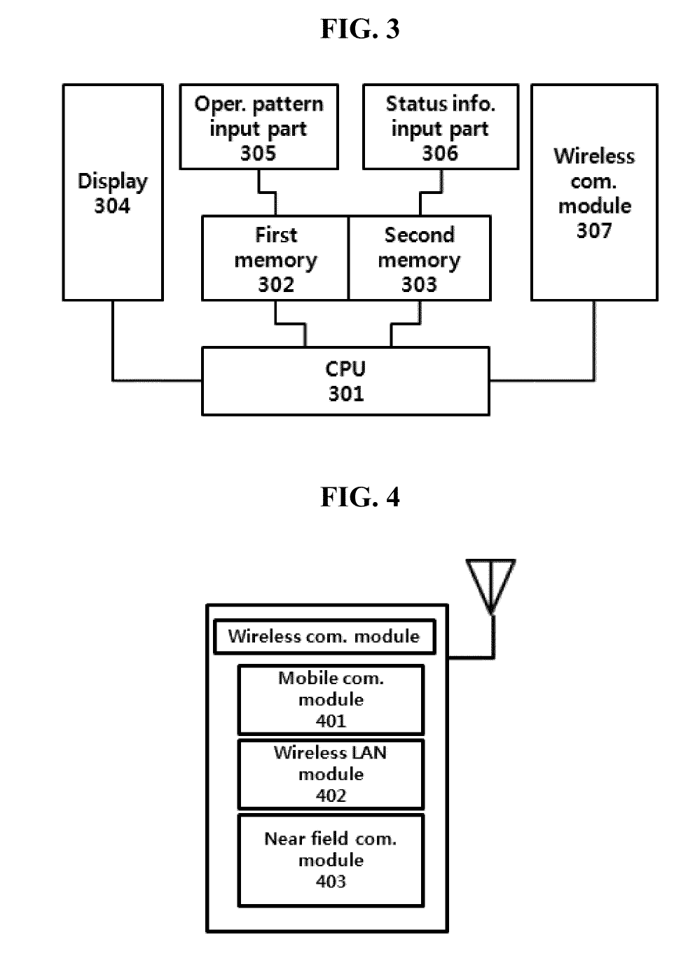

An important element for remote control is a controller (209). The controller (209) receives commands from the outside and then controls the devices including a heater. FIG. 3 shows the components of the controller (209). An operation pattern input part (305) is configured for a user to input a prescribed operation. An operation inputted by a user is stored in a first memory (302). The operation patterns or series of operations widely used in heat treatment process can be input in advance by a manufacturer of the heat treatment system. A user can store various operation patterns suitable for particular metals.

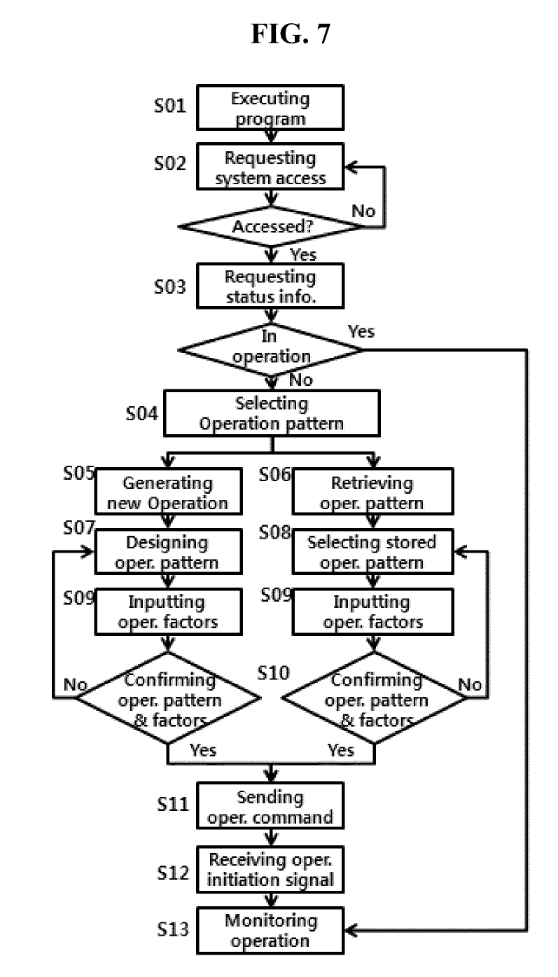

For example when the target material is Inconnel, an operation pattern as shown in FIGS. 6(a)-6(c) can be stored. The operation pattern A of FIG. 6(a) is used for annealing when the target material is Inconnel 600. In the operation pattern A, the temperature is increased up to T1 and maintained for P1 period. Thereafter, a furnace cooling (“FC”) is followed, which is performed by cooling naturally without applying additional cooling method. Depending on the targeted material property, and the operation factors, T1 and P1 can be adjusted. In this instance T1 may be 1010° C. and P1 may be 0.25 hour.

The operation pattern B may be used for annealing Inconnel 625. In the operation pattern B, the temperature is increased up to T1 and maintained for P1 period. Thereafter, a rapid cooling (“RC”) is performed, which is performed by supplying outer gas into a chamber. Likewise, similar to the operation pattern A, the temperature T1 and P1 period can be adjusted in order to meet the targeted material property. The T1 temperature may be 899° C. and the P1 period may be 4 hours.

The operation pattern C of FIG. 6(a) may be used for continuing precipitation hardening and aging for Inconnel 718. In the operation pattern C, the temperature is increased up to T1 and maintained for the P1 period. A furnace cooling is followed down to T2. Next, a temperature T2 is maintained for a P2 period and rapid cooling is followed thereafter. For this operation pattern C, general operation factor values for T1, P1, T2, and P2 may be 720° C., 8 hours, 620° C., and 18 hours, respectively.

An operation pattern which are newly input by user or preset by manufacturer may have several steps of temperature change, which are more complicated than the operation pattern C. Alternatively, it may have a simple step of temperature change and maintaining the changed temperature until receiving a command to change into a different operation pattern.

A status information input part (306) of FIG. 3 may receive a status information of the heat treatment system. The status information includes status information in a chamber (temperature, pressure or gas density) and/or operation status information of the external devices (normal operation or failure). All received status information of heat treatment system may be stored in a second memory (303).

A controller includes a wireless communication module (307). The wireless communication module may include a mobile communication module (401) supporting GSM, CDMA2000, WCDMA and LTE, a wireless LAN module (402), and/or a near field communication module (403) supporting Bluetooth, Zigbee and so on.

The controller (207) further includes a display device (304). The display device can display operation pattern which is being input by a user, or was input by the manufacturer, status information of the heat treatment system, and/or operation command received by the wireless communication module.

A processor (301) of the controller (209) retrieves an operation pattern stored in the first memory based on operation command information received through the wireless communication module such as operation pattern and operation factor, and sets an operation cycle using operation factor(s). As a heat treatment process begins, the processor (301) controls other devices including the heater to follow the preset operation cycle while comparing the state information stored in the second memory (303) with the operation cycle in real time.

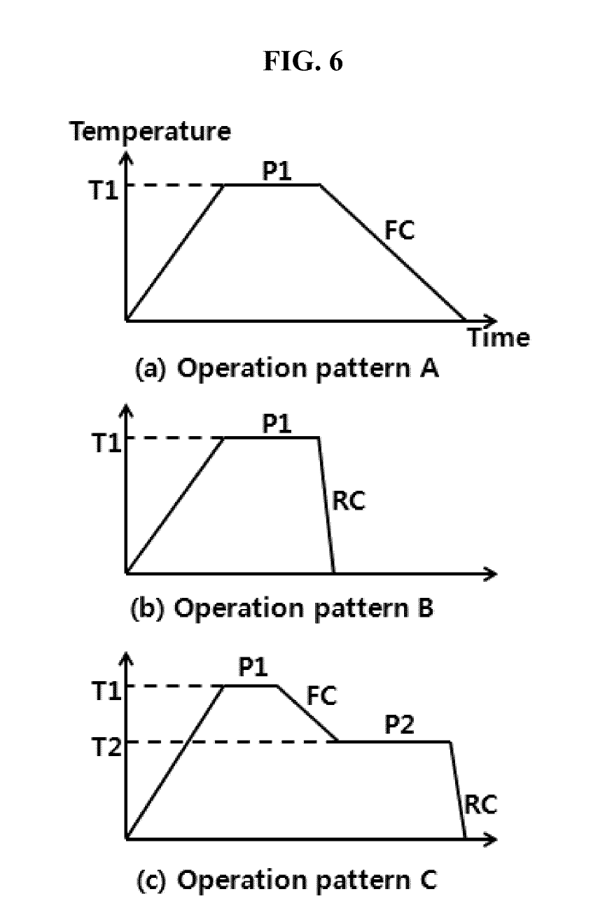

A wireless network configuration for remotely-controlled heat treatment system is shown in the FIG. 5. The wireless network configuration comprises a heat treatment apparatus (502) which wirelessly receives operation command(s) and send its status information, a portable terminal (501), which a user can provide operation command(s) to the heat treatment apparatus and can monitor operation status of the heat treatment apparatus, a base station (503) or a wireless LAN AP (Access Point) (505), which allows wireless communication with the portable terminal (501) and the heat treatment apparatus, and IP network (504), which is linked with the base station and the AP.

The portable terminal and the heat treatment apparatus can communicate selectively with the base station or the wireless LAN AP by determining a wireless signal strength. In case that a user remotely controls a plurality of heat treatment apparatus, each heat treatment apparatus may independently select appropriate communication method(s), the base station or the AP, depending on local circumstances.

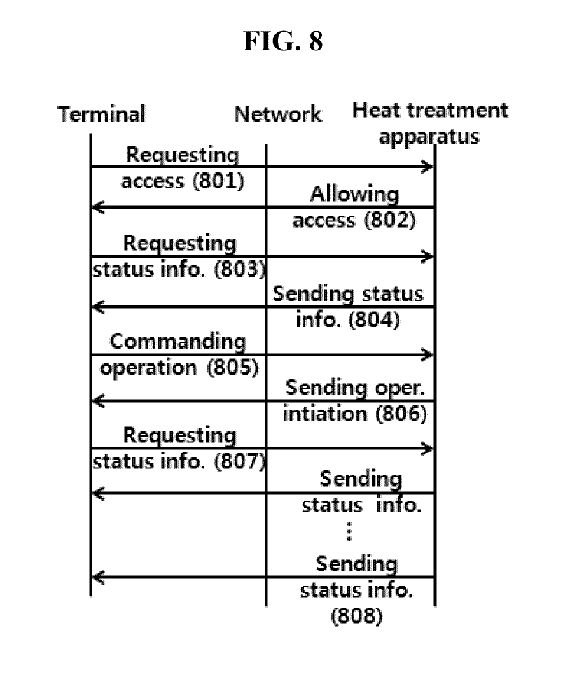

The steps for remotely controlling a heat treatment system by a portable terminal are shown in the FIG. 7 and FIG. 8. A user may execute an application program for the remotely-controlled heat treatment system on his/her portable terminal (S01). After the application program is executed, an access request signal is sent to the remotely-controlled heat treatment system (S02). In case that the user controls a plurality of heat treatment apparatus or another remotely-controllable device, such as a home appliance or a car, including a heat treatment apparatus, the user can request access to a particular heat treatment apparatus through additional selection step(s).

An access request signal may include an ID information for heat treatment apparatus, an ID information for user, and a password. The heat treatment apparatus may send an access approval message after a confirmation that information in an access request signal matches with the preset information. After the portable terminal confirms an access approval message, it requests a current status information of the heat treatment apparatus and displays the status information on the terminal display (S03).

If the current heat treatment apparatus is already being operated, the terminal proceeds to an operation monitoring mode (S13). Otherwise, the process proceeds to the next step of the operation command mode, where the user can send an operation command. The operation command mode may require a decision on the operation pattern (S04). The operation pattern may be selected from preset operation patterns (S05), or may be newly generated (S06). For selecting a preset operation pattern from stored ones, the user may be provided graph for the operation pattern(s) on his/her terminal to be easily selected by clicking corresponding graph(s) (S08). In a case that the user generates a new operation pattern, a method for drawing operation pattern in graph can be provided on the terminal display. The user can generate an operation pattern by drawing a simple graph in the time and temperature axes and by setting heating rate or cooling rate, if necessary (S07).

After an operation pattern is selected, the operation factors for the operation pattern are input (S09). The operation factors may be temperature, time, pressure and/or cooling method. Thereafter, it is confirmed that the user has determined correct operation pattern(s) and input correct operation factors (S10). If correct, a operation command data queue, which includes the operation pattern and operation factors may be generated and sent to the heat treatment apparatus (S11). The heat treatment apparatus programs an operation cycle, using the operation pattern and operation factors which are included the operation command data queue, and initiates the operation cycle. The portable terminal may change to an operation monitoring mode after an operation initiation signal is received (S13).

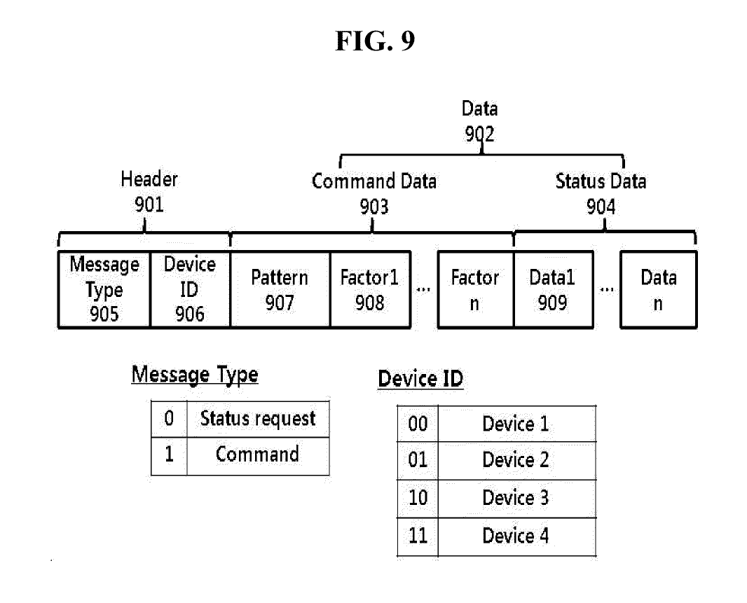

A data format is shown in the FIG. 9, which is transferred between the portable terminal and the heat treatment apparatus to request or send the status information of the heat treatment apparatus, or to give an operation command to the heat treatment apparatus. The data format may include a header part (901) and a data part (902). The data part may include a command data (903) and a status data (904). The header part may include a message type (905) and a device ID (906).

The message type of ‘0’, corresponds to requesting or sending of status information. The message type of ‘1’, corresponds to an operation command. If the message type ‘1’ for a command, the status data in the data format are ignored. To the contrary, in case the message type is ‘0’, the status data in the data format are used, but the command data are ignored.

The device ID (906) represents the ID information of remotely controlled heat treatment apparatus. If the user remotely controls multiple heat treatment apparatus or another kind of device (like home appliance) as well as heat treatment apparatus, those multiple devices can be controlled by assigning an ID for each device.

The front part of the command data may include the operation pattern (907) that the user has selected, and the rear part may correspond to the operation factors (908) that the user has input. For instance, in the annealing operation of Inconnel 600 where operation factors T1 and P1 are set as 1010° C. and 0.25 hour respectively, the data queue may include the following of the message type (905) of ‘1’, the device ID (906) of ‘00’, the operation pattern (907) of ‘A’, the operation factor 1 (908) of ‘1010’, the operation factor 2 of ‘0.25’, the status data (904) may be ‘0’.

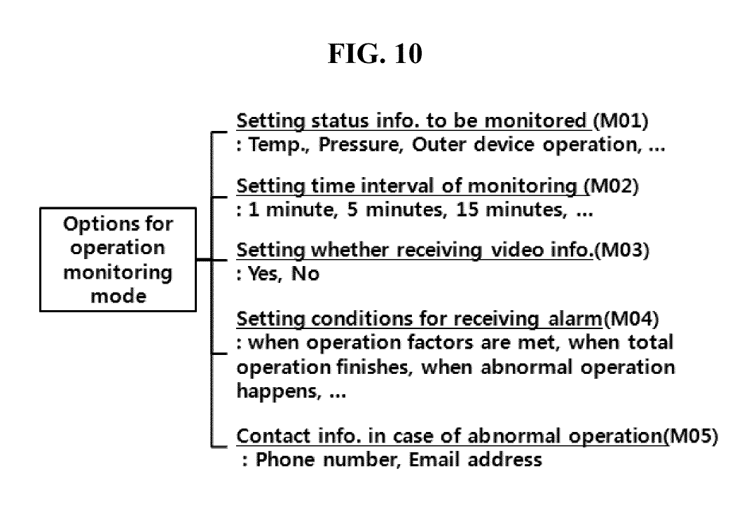

As shown in FIG. 10, in order to increase user convenience in the operation monitoring mode, additional options may be selected. The types of the status information to be monitored can be selected (M01). The temperature is set to be monitored by default, and the pressure or the operation of supplemental devices may be set to be monitored additionally. Another option, the time interval for receiving the status information, e.g., the monitoring time interval, may be set (M02). A suitable monitoring time interval may be recommended to the user based on the total time of the operation cycle.

The heat treatment apparatus may comprise a transparent window in the shell, and it can further comprise a camera which can monitor the inside of the shell through the window. In case a camera is provided, the option which enables to see the inside of the shell in real time can be provided, subject to whether high-speed wireless internet is available (M03).

In the option setting, an alarm function can be set (M04). The alarm function allows the user to be informed through a speaker or a vibrator whether certain condition(s) is met. Such condition(s) may be when an operation factor that the user input is reached, when the total operation cycle is finished, or when an abnormal operation occurs. As an additional option, a telephone number or an email address with which abnormal operation is notified to the user can be input (M05).

In the operation monitoring mode, the user may view within a certain time interval the status information of the heat treatment apparatus, which is sent to the terminal from the heat treatment apparatus. The transmission of the status information from the heat treatment apparatus to the terminal may be made without particular request. Alternatively, it can be made in response to a request to send the status information after the request is sent from the terminal within a certain regular time interval (808). In the operation monitoring mode, if the display of the terminal is continuously in an activated status, it leads to higher power loss of the terminal. Thus, except the case where the user sets the display, in the case where the status information is received in a regular time interval at the remote control program for the heat treatment apparatus, the display of the terminal can be set to be activated only when an alarm is made, not activated all the time.

What is claimed is:

1. A heat treatment system comprising:
a chamber which is separate from the outside, and of which temperature is controlled by a preset operation pattern;
a heating device to heat the chamber;
a cooling device to cool the chamber;
a gas supply device to supply outer gas into the chamber;
at least one sensor to detect a status of the chamber;
a power supply device to supply power to the heating device, the cooling device, and an gas supply unit;
a battery connected to the power supply device;
a first memory where a plurality of operation pattern is stored;
a second memory where status information measured from the senor is stored;
a wireless communication module to receive an operation pattern selection command and an operation factor related to the operation pattern; and
a controller which retrieves an operation pattern from the first memory according to the operation pattern selection command received and controls at least two out of the heating device, the cooling device, and the gas supply device, based on the operation pattern retrieved and the operation factor.

2. The system according to claim 1, wherein the cooling device is located at the outside of the chamber.

3. The system according to claim 1, wherein the battery supplies power to at least one of the heating device, the cooling device, and the gas supply device by the control of a power supply control device.

4. The system according to claim 1, wherein the first memory and the second memory is located in a same memory chip.

5. The system according to claim 1, wherein each of a plurality of operation patterns stored in the first memory has ID to identify itself.

6. The system according to claim 1, wherein a data transferred via wireless communication comprises a device ID, an operation pattern ID, and at least one operation factor.

7. The system according to claim 1, wherein a data transferred via wireless communication comprises information to determine whether the data is an operation command, or a request for operation status information.

8. The system according to claim 1, wherein in case that a data transferred via wireless communication is operation command, information not related with operation command in the data are ignored.

9. The system according to claim 1, wherein in case that the status of the chamber reaches a preset operation condition, the wireless communication module sends the status information.

10. The system according to claim 1, wherein in case that power is supplied by the battery due to failure in the supply of outside power, the wireless communication module sends alarm.

11. The system according to claim 1, wherein the wireless communication module sends current status information of the chamber and estimated time up to reaching the operation factor.

12. A remotely controlled heat treatment system comprising:
A heat treatment apparatus configured to wirelessly receive an operation pattern selection command and an operation factor relevant to an operation pattern, to retrieve an operation pattern from a memory based on the operation pattern selection command, and to control the temperature of a chamber separated from the outside by at least two of a heating device, a cooling device, and an outer gas supply device according to the retrieved operation pattern and the received operation factor;
a portable terminal where a program relevant to the heat treatment apparatus, received from the outside, to be stored and executed, and the executed program enables to select one of a plurality of stored operation patterns, for an operation factor relevant to the selected operation pattern to be inputted, and to generate and send a data queue comprising information of the selected operation pattern and the inputted operation factor outside the portable terminal; and
a base station or access point configured to wirelessly deliver data between the heat treatment apparatus and the portable terminal.

13. A method for remotely controlling a heat treatment system comprising;
connecting a heat treatment apparatus with a portable terminal for wireless communication between them;
receiving a data queue generated from the portable terminal, the data queue containing information of an operation pattern and an operation factor relevant to the operation pattern, the operation pattern being selected from a plurality of stored operation patterns in the portable terminal, and the operation factor inputted on the portable terminal;
sending the status information of a chamber separate from the outside space, the temperature of the chamber being controlled by at least two of a heating device, a cooling device, and an outer gas supply device according to the operation pattern and the operation factor; and
generating alarm signal to inform a user when the status of the chamber reaches to a preset condition.
